(19) United States
(12) Patent Application Publication
(10) Pub. No.: US 2010/0074204 A1
(43) Pub. Date: Mar. 25, 2010

(54) UPLINK HYBRID AUTOMATIC REPEAT REQUEST OPERATION DURING RANDOM ACCESS

(75) Inventor: Arnaud Meylan, Bois-Colombes (FR)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/560,149

(22) Filed: Sep. 15, 2009

Related U.S. Application Data
(60) Provisional application No. 61/097,307, filed on Sep. 16, 2008.

(51) Int. Cl. H04W 72/04; H04L 1/18

(52) U.S. Cl. 370/329; 714/748

(57) ABSTRACT

Systems and methodologies are described that effectuate or facilitate avoidance of deadlock conditions during random access procedures. In accordance with various aspects set forth herein, systems and/or methods are provided that receive an uplink grant that specifies a hybrid automatic repeat request (HARQ) process identifier. The HARQ process identifier is analyzes to identify whether the identifier is associated with an ongoing random access procedure. The uplink grant is utilized for a data transmission when the identifier is not associated with the ongoing random access procedure.

### CLAIM OF PRIORITY UNDER 35 U.S.C. §119

This application claims the benefit of U.S. Provisional Patent application Ser. No. 61/097,307 entitled “UPLINK HARQ OPERATION DURING RANDOM ACCESS”, filed Sep. 16, 2008, which is assigned to the assignee hereof. The entirety of the aforementioned application is hereby incorporated by reference.

### BACKGROUND

I. Field

The following description relates generally to wireless communications, and more particularly to optimizing hybrid automatic repeat request (HARQ) operation during random access to avoid deadlocks and verifying uplink grants are appropriate.

II. Background

Wireless communication systems are widely deployed to provide various types of communication content such as voice and data, Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), LTE Advanced (LTE-A), etc.

As the demand for high-rate and multimedia data services rapidly grows, there has been an effort toward implementation of efficient and robust communication systems with enhanced performance. For example, in recent years, users have started to replace fixed line communications with mobile communications and have increasingly demanded great voice quality, reliable service, and low prices.

Generally, wireless multiple-access communication systems may simultaneously support communication for multiple mobile devices. Each mobile device may communicate with one or more base stations via transmissions on forward and reverse links The forward link (or downlink) refers to the communication link from base stations to mobile devices, and the reverse link (or uplink) refers to the communication link from mobile devices to base stations.

To utilize a wireless communication network, a mobile device first detects a cell with the network and acquires synchronization with the cell. After synchronization, the mobile device can receive and decode system information which provides configuration information and/or other parameters that facilitate utilization of the network. Subsequently, the mobile device can request setup of a connection with the cell via a random access procedure.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with various aspects of the subject disclosure, a method is provided. The method includes obtaining an uplink grant that specifies a first HARQ process identifier. The method can also comprise identifying whether the first HARQ process identifier is associated with an ongoing random access procedure. In addition, the method can include disregarding the uplink grant when the first HARQ process identifier is associated with the ongoing random access procedure.

A second aspect described herein relates to an apparatus. The apparatus can comprise a random access module that facilitates a random access procedure, wherein the random access procedure results in at least one of creation of a radio link or reacquisition of uplink synchronization. The apparatus can also include a HARQ module that facilitates HARQ operations for one or more data transmissions. Moreover, the HARQ module includes a HARQ process with a first identifier, the HARQ process is employed to facilitate transmission of a scheduled uplink message generated by the random access module, and the HARQ module ignores an uplink grant that includes the first identifier when the uplink grant specifies a new transmission.

According to another aspect, a wireless communication apparatus is described. The wireless communication apparatus can include means for receiving a random access response that includes a first uplink grant and a first HARQ process identifier. In addition, the wireless communication apparatus can comprise means for utilizing a set of resources specified in the first uplink grant and a HARQ process specified by the first HARQ process identifier to transmit a scheduled uplink message. Further, the wireless communication apparatus can include means for receiving a second uplink grant that includes a second HARQ process identifier. The wireless communication apparatus can also include means for comparing the first HARQ process identifier and the second HARQ process identifier. Further, the wireless communication apparatus can comprise means for employing the second uplink grant for a data transmission when the first HARQ process identifier is different from the second HARQ process identifier.

Still yet another aspect relates to a computer program product, which can comprise a computer-readable medium that comprises code for causing at least one computer to evaluate a random access response to ascertain a first set of resources and a first HARQ process specified in the random access response. The computer-readable medium can further include code for causing the at least one computer to employ the first set of resources to transmit a scheduled uplink message that includes an identity of a mobile device. Moreover, the computer-readable medium can include code for causing the at least one computer to utilize the first HARQ process to facilitate error-free transmission of the scheduled uplink message. The computer-readable medium can also include code for causing the at least one computer to evaluate a second uplink grant to determine a second set of resources and a second HARQ process. In addition, the computer-readable medium can comprise code for causing the at least one computer to disregard the second uplink grant when the first HARQ process is identical to the second HARQ process.

Another aspect relates to a wireless communication apparatus comprising a processor configured to evaluate a random access response that includes a first uplink grant and a first HARQ process identifier. The processor can further be configured to employ a set of resources specified in the first uplink grant and a HARQ process specified by the first HARQ process identifier to transmit a scheduled uplink message. Moreover, the processor can be configured to receive a second uplink grant that includes a second HARQ process identifier. The processor can also be configured to compare the first HARQ process identifier and the second HARQ process identifier. In addition, the processor can be configured to utilize the second uplink grant for a data transmission when the first HARQ process identifier is different from the second HARQ process identifier.

According to another aspect, a method is described. The method can include selecting a first HARQ process identifier to include in a random access response, including the first HARQ process identifier in a set of active identifiers that utilized for random access procedures by one or more mobile devices, and incorporating a second HARQ process identifier in an uplink grant, wherein the second HARQ process identifier is not included in the set of active identifiers.

In accordance with a further aspect of the subject disclosure, an apparatus is disclosed. The apparatus comprises a memory that retains instructions related to selecting a first HARQ process identifier to include in a random access response, including the first HARQ process identifier in a set of active identifiers that utilized for random access procedures by one or more mobile devices, and incorporating a second HARQ process identifier in an uplink grant, wherein the second HARQ process identifier is not included in the set of active identifiers. Additionally, the apparatus also includes a processor, coupled to the memory, configured to execute the instructions retained in the memory.

In accordance with yet a further aspect of the subject disclosure, a wireless communication apparatus is provided. The wireless communication apparatus comprises means for selecting a first HARQ process identifier to include in a random access response, means for adding the first HARQ process identifier in a set of active identifiers that utilized for random access procedures by one or more mobile devices, and means for incorporating a second HARQ process identifier in an uplink grant, wherein the second HARQ process identifier is not included in the set of active identifiers.

In accordance with a further embodiment of the subject disclosure a computer program product is disclosed. The computer program product includes computer-readable medium comprising: code for causing at least one computer to select a first HARQ process identifier to include in a random access response, code for causing the at least one computer to add the first HARQ process identifier in a set of active identifiers that utilized for random access procedures by one or more mobile devices, and code for causing the at least one computer to incorporate a second HARQ process identifier in an uplink grant, wherein the second HARQ process identifier is not included in the set of active identifiers.

In accordance with further embodiments of the subject disclosure a wireless communications apparatus is disclosed wherein the wireless communications apparatus includes a processor configured to select a first HARQ process identifier to include in a random access response, include the first HARQ process identifier in a set of active identifiers that utilized for random access procedures by one or more mobile devices, and incorporate a second HARQ process identifier in an uplink grant, wherein the second HARQ process identifier is not included in the set of active identifiers

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 illustrates an example wireless communication system that optimizes hybrid automatic repeat request operation during random access in accordance with various aspects.

FIG. 3 is an illustration of an example system that facilitates execution of a random access procedure in accordance with various aspects.

FIG. 4 is an illustration of an example system that facilitates operation of hybrid automatic repeat requests in accordance with various aspects.

FIG. 5 is an illustration of an example methodology for avoiding a deadlock condition during random access in accordance with various aspects.

FIG. 6 is an illustration of an example methodology for verifying that a random access transmission is possible with a given uplink grant in accordance with various aspects.

FIG. 7 is an illustration of an example methodology for avoiding a deadlock condition during random access in accordance with various aspects

FIG. 8 is an illustration of an example system that facilitates avoidance of deadlock situations during random access in accordance with various aspects.

FIG. 9 is an illustration of an example system that facilitates avoidance of deadlock situations during random access in accordance with various aspects.

FIGS. 10-11 are block diagrams of respective wireless communication devices that can be utilized to implement various aspects of the functionality described herein.

FIG. 12 is a block diagram illustrating an example wireless communication system in which various aspects described herein can function.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to computer-related entities such as: hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as, in accordance with a signal, having one or more data packets (e.g., data from one component interacting with another component in a local system, distributed system, and/or across a network such as the Internet with other systems by way of the signal).

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point, Node B, or evolved Node B (eNB)) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE, LTE-A, SAE, EPC, and GSM are described in documents from an organization named “3rd Generation Partnership Project” (3GPP). Further, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects will be presented in terms of systems that can include a number of devices, components, modules, and the like. It is to be understood and appreciated that the various systems can include additional devices, components, modules, etc. and/or not include all of the devices, components, modules etc. discussed in connection with the figures. A combination of these approaches can also be used.

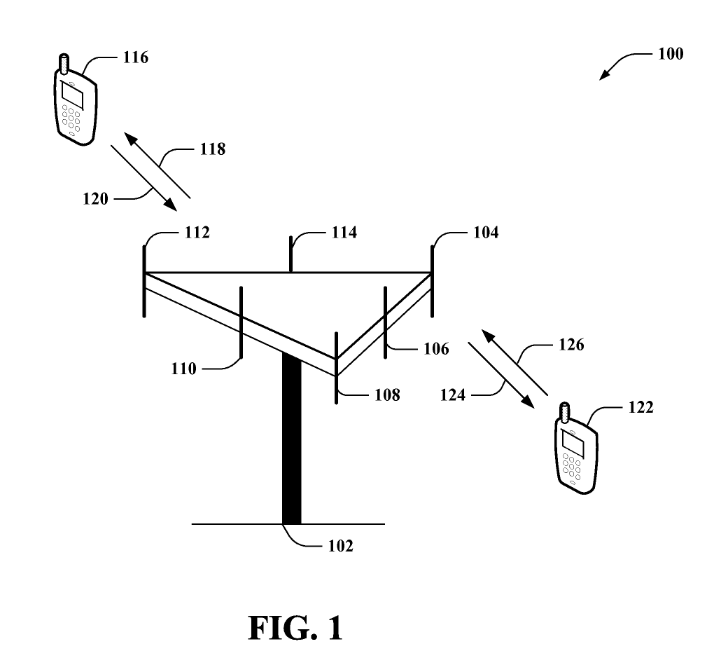

Referring now to FIG. 1, a wireless communication system 100 is illustrated in accordance with various embodiments presented herein. System 100 comprises a base station (e.g., access point) 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more UEs such as UE 116 and UE 122; however, it is to be appreciated that base station 102 can communicate with substantially any number of UEs similar to UEs 116 and 122. UEs 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, UE 116 is in communication with antennas 112 and 114, where antennas 112 and 114 transmit information to UE 116 over a downlink 118 and receive information from UE 116 over an uplink 120. Moreover, UE 122 is in communication with antennas 104 and 106, where antennas 104 and 106 transmit information to UE 122 over a downlink 124 and receive information from UE 122 over an uplink 126. In a frequency division duplex (FDD) system, downlink 118 can utilize a different frequency band than that used by uplink 120, and downlink 124 can employ a different frequency band than that employed by uplink 126, for example. Further, in a time division duplex (TDD) system, downlink 118 and uplink 120 can utilize a common frequency band and downlink 124 and uplink 126 can utilize a common frequency band.

Each group of antennas and/or the area in which they are designated to communicate can be referred to as a sector of base station 102. For example, antenna groups can be designed to communicate to UEs in a sector of the areas covered by base station 102. In communication over downlinks 118 and 124, the transmitting antennas of base station 102 can utilize beamforming to improve signal-to-noise ratio of downlinks 118 and 124 for UEs 116 and 122. Also, while base station 102 utilizes beamforming to transmit to UEs 116 and 122 scattered randomly through an associated coverage, UEs in neighboring cells can be subject to less interference as compared to a base station transmitting through a single antenna to all its UEs. Moreover, UEs 116 and 122 can communicate directly with one another using a peer-to-peer or ad hoc technology (not shown).

According to an example, system 100 can be a multiple-input multiple-output (MIMO) communication system. Further, system 100 can utilize substantially any type of duplexing technique to divide communication channels (e.g., downlink, uplink, . . . ) such as FDD, FDM, TDD, TDM, CDM, and the like. In addition, communication channels can be orthogonalized to allow simultaneous communication with multiple devices or UEs over the channels; in one example, OFDM can be utilized in this regard. Thus, the channels can be divided into portions of frequency over a period of time. In addition, frames can be defined as the portions of frequency over a collection of time periods; thus, for example, a frame can comprise a number of OFDM symbols. The base station 102 can communicate to the UEs 116 and 122 over the channels, which can be created for various types of data. For example, channels can be created for communicating various types of general communication data, control data (e.g., quality information for other channels, acknowledgement indicators for data received over channels, interference information, reference signals, etc.), and/or the like.

Upon selection of a cell associated with base station 102 via a cell search operation, UEs 116 and/or 122 can request setup of a radio connection with base station 102 via a random access procedure. In accordance with one aspect, the random access procedure can be contention-based or non-contention based. Contention-based random access can be employed by UEs 116 and/or 122 for initial access when establishing a radio link, to re-establish a radio link after radio link failure, or to establish uplink synchronization. Non-contention based or contention-free random access can be utilized for handovers between cells.

To initiate random access, UE 116 and/or UE 122 transmit a random access preamble to base station 102. In one example, the random access preamble enables the base station 102 to estimate transmission timing of UE 116 and 122. After reception of the random access preamble, the base station 102 transmits a random access response which includes a timing adjustment command and uplink resources employed by UE 116 and 122 in a subsequent stage. UEs 116 and 122 can employ the uplink resources specified in the random access response to transmit an identity to base station 102. In response to the transmission of the identity, base station 102 signals a contention-resolution message to UEs 116 and 122. The contention-resolution message resolves contention due to multiple mobile devices (e.g., UE 116 and UE 122) utilizing the same random access resources.

During transmission of the identity to base station 102, hybrid automatic repeat request (HARQ) operations are utilized to facilitate error-free transmission and reception. Accordingly, the random access response includes an uplink grant (e.g., uplink resources scheduled for the identity transmission) and an associated HARQ process identifier that indicates a HARQ process that UE 116 and/or 122 can utilize for the identity transmission. The contention-resolution message transmitted by base station 102 includes another uplink grant and an identity associated with one of the UEs 116 or 122. In one example, the contention-resolution message can include an identity associated with UE 116 thus establishing a radio link connection between UE 116 and base station 102. UE 116 employs resources specified in the uplink grant in the contention-resolution message to transmit data (e.g., user data) via an uplink channel.

Pursuant to an example, UE 116 can initiate a random access procedure when uplink and/or downlink data arrives for transmission while UE 116 is in a connected state but lacks uplink synchronization. While in a connected state, UE 116 can possess an identity previously known to base station 102. For instance, the UE 116 can retain a cell radio network temporary identifier (C-RNTI). In addition, the UE 116, in a connected state, can have ongoing or pending uplink and/or downlink transmissions with base station 102 during the random access procedure. As such, the base station 102 can transmit a dynamic uplink grant, intended to schedule resources for the pending transmission, addressed to the C-RNTI or other identifier associated with UE 116. The dynamic uplink grant can include a HARQ process identifier that specifies a HARQ process to be utilized for the scheduled transmission.

In an aspect, the HARQ process identifier included in the dynamic uplink grant can be identical to the HARQ process identifier included in the random access response. This scenario can occur, for instance, when UE 116 loses uplink synchronization, thus prompting UE 116 to initiate random access, while base station 102 schedules resources for UE 116 that are employable for uplink data. In one example, base station 102 can be unaware of the initiated random access procedure. For instance, when the random access message which identifies a mobile device (e.g., message 3 in the random access procedure) is not received and/or decoded by base station 102 prior to transmission of the dynamic grant, the base station 102 is not aware that UE 116 has an ongoing random access procedure. Accordingly, the base station 102 can include identical HARQ process identifiers in both the random access response and the dynamic uplink grant while remaining unaware that both grants target UE 116.

Typically, the dynamic uplink grant instructs UE 116 to utilize the specified HARQ process for HARQ operations during uplink transmission. The dynamic uplink grant can include a new data indicator which informs UE 116 to begin a new transmission as opposed to a retransmission. Accordingly, UE 116 flushes a buffer associated with the HARQ process. When a random access procedure is ongoing with the same HARQ process, the buffer is flushed and the message 3 is lost. According to an aspect of the subject disclosure, UE 116 can ignore uplink grants that identify a HARQ process utilized for an ongoing random access. In addition, base station 102 can track HARQ processes utilized for random access by one or more mobile devices. For instance, base station 102 can identify and retain HARQ process identifiers included in random access responses. The base station 102 can avoid utilizing random access HARQ process identifiers in dynamic uplink grants. Once random access is completed for any mobile devices utilizing a random access HARQ process identifier, the identifier can be freed for dynamic uplink grants.

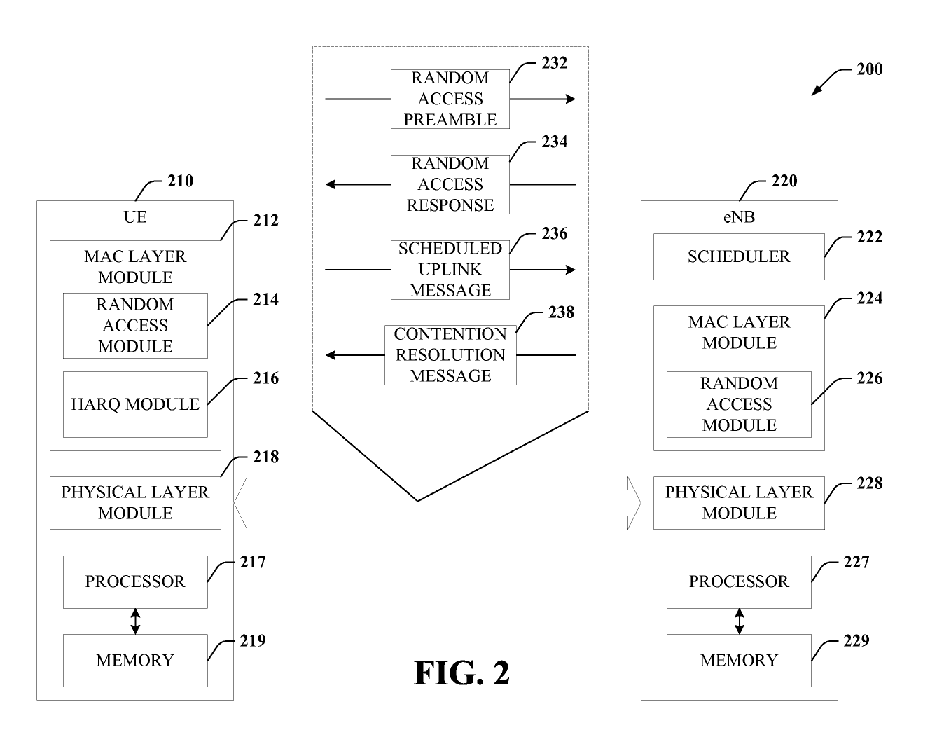

Turning to FIG. 2, illustrated is a wireless communication system 200 that optimizes hybrid automatic repeat request operation during random access in accordance with various aspects. As FIG. 2 illustrates, system 200 can include a user equipment unit (UE) 210, which can communicate with an eNodeB (eNB) 220 (e.g., a base station, an access point, a cell, etc.). While only UE 210 and eNB 220 are illustrated in FIG. 2, it should be appreciated that system 200 can include any number of UEs and/or eNBs. In accordance with an aspect, eNB 220 can transmit information to UE 210 over a forward link or downlink channel and UE 210 can transmit information to eNB 220 over a reverse link or uplink channel. It should be appreciated that system 200 can operate in an OFDMA wireless network, a CDMA network, a 3GPP LTE or LTE-A wireless network, a 3GPP2 CDMA2000 network, etc.

In an aspect, UE 210 can include a medium access control (MAC) layer module 212 and a physical layer module 218. The MAC layer module 212 can perform operations associated with the MAC layer of wireless communications. For example, the MAC layer module 212 can facilitate mapping between logical and transport channels, multiplexing/demultiplexing of MAC service data units (SDUs) into/from transport blocks (TBs) delivered to/from a physical layer, scheduling information reporting, error correction through HARQ, selecting transport formats, and the like. The physical layer module 218 can perform operations associated with the physical layer. In one example, the physical layer module 218 facilitates offering data transport services to higher layers (e.g., MAC layer, radio link control (RLC) layer, packet data convergence protocol (PDCP) layer, etc.) The physical layer module 218 can perform functions such as, but not limited to, error detection on transport channels, soft combining, rate matching of coded transport channels to physical channels, mapping of transport channels to physical channels, power weighting, modulation/demodulation, frequency and time synchronization, radio characteristics measurements, MIMO antenna processing, transmit diversity, or radio frequency processing. In general, the physical layer module 218 facilitates preparation and transmission of a data packet over a radio link, wherein the data packet (e.g., a MAC protocol data unit PDU or transport block) is generated by the MAC layer module 212. In addition, the physical layer module 218 facilitates reception of a data packet over the radio link and delivers the received data packet to the MAC layer module 212 for further processing. In another aspect, eNB 220 can include a MAC layer module 224 and physical layer module 228, which can provide similar functionality to eNB 220 as MAC layer module 212 and physical layer module 218 provide to UE 210.

According to an example, UE 210 can initiate a random access procedure with eNB 220 in order to establish an initial radio link, re-establish a link after a failure, reacquire uplink synchronization, or the like. UE 210 and eNB 220 include respective random access modules 214 and 226 to facilitate random access. While random access modules 214 and 226 are depicted as included within MAC layer modules 212 and 224, respectively, it should be appreciated that random access modules 214 and 226 can be standalone modules and/or incorporated into any other suitable module.

In accordance with an aspect, a random access procedure can comprise at least four messages exchanged between UE 210 and eNB 220. To initiate random access, UE 210 transmits a random access preamble 232 to eNB 220 on random access resources specified in system information broadcasted by eNB 220. Upon reception of the random access preamble 232, eNB 220 transmits a random access response 234. The random access response 234 can include a temporary identifier such as a temporary C-RNTI assigned to UE 210. In addition, the random access response 234 can include an uplink grant which indicates resources on which a third message (e.g., message 3) should be transmitted. To continue random access, UE 210 transmits message 3 or a scheduled uplink message 236 on the resources specified in the random access response 234. In one aspect, message 3 (scheduled uplink message) 236 includes an identity of UE 210 in the form of an identifier. For instance, the identifier can be the temporary C-RNTI included in the random access response 234, a C-RNTI assigned to UE 210 previously, a core network identifier, or any suitable identifier. The eNB 220 transmits a contention resolution message 238 to conclude random access for UE 210.

In one example, a probability exists that more than one mobile device selects a single random access preamble simultaneously in parallel random access attempts. As such, the random access response 234 is detected and utilized by more than one mobile device to transmit respective messages that include respective identities. The contention resolution message 238 includes an identifier of one mobile device to indicate which mobile device survives the collision. For instance, the contention resolution message 238 can include the identifier transmitted by UE 210 in the scheduled uplink message 236. The UE 210 promotes the temporary C-RNTI and utilizes the C-RNTI for further communication.

In an aspect, UE 210 can initiate random access to reacquire uplink synchronization and to continue ongoing data transmissions. As such, UE 210 possesses a valid C-RNTI, known to eNB 220, acquired from a previous successful random access. While UE 210 performs random access to reacquire synchronization, eNB 220 can attempt to signal dynamic uplink grants to UE 210 utilizing the known C-RNTI. The dynamic uplink grants can disrupt random access and lead to deadlocks. In accordance with one or more aspects, MAC layer module 212 (and particular random access module 214) can be configured to avoid deadlock situations.

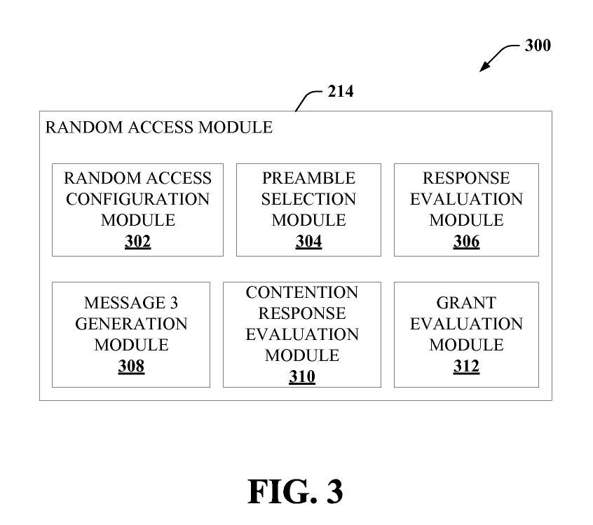

Turning briefly to FIG. 3, a system 300 is depicted that facilitates execution of a random access procedure in accordance with various aspects. System 300 includes a representative random access module 214 which can be utilized to mitigate deadlocks during random access. The random access module 214 can include a random access configuration module 302 that facilitates configuration of a set of parameters employed during random access. In addition, the random access module 214 can include a preamble selection module 304 that selects a preamble from a set of preambles to transmit during the initial stage of random access. Further, the random access module 214 can include a response evaluation module 306 that analyzes random access responses transmitted by a base station. The random access module 214 can also include a message 3 generation module 308 that constructs a message to be transmitted during a third step of random access, a contention response evaluation module 310 that analyzes a contention resolution message to identify successful or unsuccessful contention resolution, and a grant evaluation module 312 that analyzes an uplink grant to determine if the uplink grant accommodates a particular transport block size.

Referring back to FIG. 2, the representative random access module 214 depicted in FIG. 3, can be employed to facilitate random access by UE 210, which is initiated to reacquire uplink synchronization. UE 210 can employ the random access configuration module 302 to initialize a random access procedure. In accordance with an example, the random access configuration module 302 can initialize a set of parameters that include parameters such as, but not limited, a set of physical random access channel (PRACH) resources available for transmission of preambles, groups of preambles and available preambles in each group, a number of message 3 HARQ transmissions, a contention resolution timer value, and the like.

UE 210 can utilize the preamble selection module 304 to select a random access preamble to transmit. In an aspect, a preamble is pseudo-randomly selected from one of the preamble groups and a preamble group can be selected based upon an amount of data to be transmitted in the scheduled uplink message 236. In an example, two groups of preambles can be configured. A first group includes a set of preambles to be utilized when the amount of data to be transmitted in the scheduled uplink message 236 (e.g., message 3) is below or equal to a predetermined threshold (e.g., a parameter configured by the random access configuration module 302). A second group includes a set of preambles to be employed when the amount of data is greater than the threshold. Pursuant to this example, the preamble selection module 304 can determine an amount of data to be transmitted in the scheduled uplink message 236 and compare the amount with the predetermined threshold to identify a group of preambles from which a selection is to be made. Subsequently, the preamble selection module 304 can pseudo-randomly select a preamble from the identified group (e.g., the group corresponding to the amount of data to be transmitted). The selected preamble can be included in a preamble message (e.g., random access preamble 232) transmitted to eNB 220 to commence random access.

The eNB 220 can utilize a random access module 226 to evaluate the received random access preamble 232. The random access module 226 can identify a group from which the random access preamble 232 was selected and, accordingly, an estimate of the amount of data to be transmitted in the scheduled uplink message 236. The estimate of the amount of data can be provided to scheduler 222 which schedules and assigns radio resources to one or more mobile devices to accommodate uplink and downlink data transmissions. The scheduler 222 can employ the estimate to identity uplink resources for transmission of the scheduled uplink message 236. The uplink resources can be specified in an uplink grant included in a random access response 234 prepared by the random access module 226 and transmitted to UE 210.

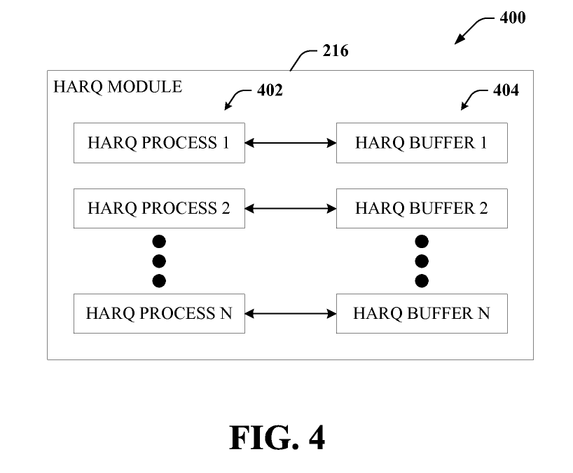

In addition to the uplink grant, the random access response 234 can include a HARQ process identifier which indicates a HARQ process of UE 210 to be employed in transmitting the scheduled uplink message 236. HARQ processes are managed by HARQ module 216 and each process performs HARQ operations for a respective transmission. Turning briefly to FIG. 4, a system 400 is depicted that includes a representative HARQ module 216. The HARQ module 216 includes a set of HARQ processes 402 and a set of respective HARQ buffers 404. The set of HARQ processes 402 can include N processes where N is an integer greater than or equal to one. According to an aspect, each HARQ process can be indicated by a respective index or identifier. For example, HARQ process 1 can be indicate by the HARQ process identifier 1.

Returning to FIGS. 2 and 3, UE 210 can employ a response evaluation module 306 to analyze the random access response 234 to determine uplink resources in the uplink grant and a HARQ process identifier. The HARQ process identifier is reported to the HARQ module 216 to initialize the corresponding HARQ process for transmission of the scheduled uplink message 236 after generation by the message 3 generation module 308. In one example, the message 3 generation module 308 can include C-RNTI associated with UE 210 in the scheduled uplink message 236 when UE 210 is utilizing random access to reacquire uplink synchronization. In another example, a network identifier that uniquely indicates an identity of UE 210 can be included when UE 210 is utilizing random access for initial access.

After transmission of the scheduled uplink message 236, random access module 226 of eNB 220 can prepare a contention resolution message 238 which includes an uplink grant for user data transmissions and an identifier associated with UE 210 which was transmitted in the scheduled uplink message 236. For example, the identifier can be a C-RNTI or a network identifier associated with UE 210. UE 210 can employ the contention response evaluation module 310 to analyze the contention resolution message 238. In an aspect, the contention response evaluation module 310 determines if the contention resolution message 238 includes an identifier associated with UE 210 and transmitted in the scheduled uplink message 236. If the contention resolution message 238 includes the identifier, then UE 210 considers contention resolution successful and random access completes.

In an aspect, UE 210 can utilize random access to reacquire uplink synchronization. As such, a valid C-RNTI is packaged in the scheduled uplink message 236 by the message 3 generation module 308. Moreover, UE 210 can have data transmissions pending prior to initiation of random access. Pursuant to this scenario, a dynamic uplink grant associated with a pending data transmission can be similar in appearance to the contention resolution message 238 since both messages identify UE 210 via the C-RNTI. A dynamic uplink grant can include a HARQ process identifier associated with the random access procedure. Further, the dynamic uplink grant can include a new data indicator which instructs the identified HARQ process to flush a respective buffer and prepare for a new transmission, thus disrupting the random access procedure. The contention response evaluation module 310 can evaluate the contention resolution message 238 to determine a HARQ process identifier included therein in association with the uplink grant. If the HARQ process identifier matches the identifier included in the random access response 234 and utilized for transmission of the scheduled uplink message 236, the uplink grant is ignored to prevent a deadlock. In an aspect, UE 210 ignores uplink grants, including contention resolution messages, during random access if the uplink grant leads to a new transmission using a HARQ process identifier employed for random access (e.g., a HARQ buffer associated with the identifier includes a MAC PDU corresponding to the scheduled uplink message 236). The HARQ module 216 of UE 210 ignores the grant as the grant instructs the HARQ module 216 to commence a new transmission which would disrupt random access and lead to deadlocks.

In accordance with another aspect, the random access module 226 of eNB 220 can coordinate to avoid uplink grants that disrupt random access. The random access module 226 can monitor and track HARQ process identifiers included in random access responses. The HARQ process identifiers can be included in a set of active identifiers which is retained. Each HARQ process identifier can be retained until a random access procedure associated therewith is completed. When preparing a contention resolution message 238, the random access module 226 avoids identifiers included in the set of active identifiers. The random access module 226 selects an identifier for the contention resolution message 238 that is disjoint with the set of active identifiers. Thus, the random access module 226 prepares contention resolution messages with uplink grants that do not lead to transmissions that utilize HARQ processes identified in the set of active identifiers. After transmission of a contention response message to a mobile device, the random access module 226 can remove a HARQ process identifier, associated with the mobile device, from the set of active identifiers.

In another aspect, UE 210 can utilize the grant evaluation module 312 to analyze uplink grants included in the random access response 234, the contention resolution message 238, or any other suitable uplink grant transmitted on a physical downlink control channel (PDCCH). The grant evaluation module 312 determines whether the uplink grants accommodate a transmission of the scheduled uplink message 236 (e.g., the resources assigned in the grants are great enough to enable transmission of a transport block associated with the scheduled uplink message 236). The grant evaluation module 312 enables UE 210 to utilize an uplink grant that triggers transmission of the scheduled uplink message 236 only when the grant accommodates the associated transport block.

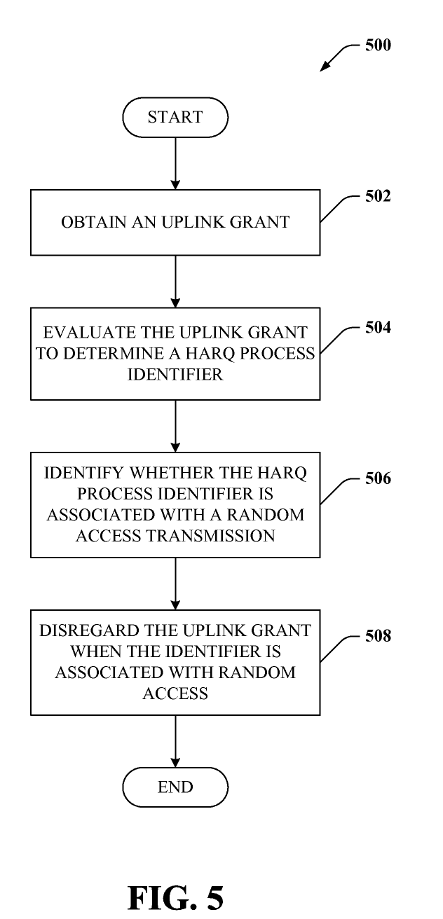

Referring to FIGS. 5-7, methodologies related to avoiding deadlock conditions during random access are described. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 5, illustrated is a method 500 for avoiding a deadlock condition during random access in accordance with various aspects. Method 500 can be employed, for example, by a mobile device with an ongoing random access procedure. At reference numeral 502, an uplink grant is obtained. The uplink grant can be a dynamic uplink grant or an uplink grant associated with a contention resolution message. At reference numeral 504, the uplink grant is evaluated to determine a HARQ process identifier included therein. At reference numeral 506, it is identified whether or not the HARQ process identifier is associated with a random access transmission. For example, the random access transmission can be a scheduled uplink message (e.g., a message 3 transmission). At reference numeral 508, the uplink grant is disregarded when the HARQ process identifier is associated with random access.

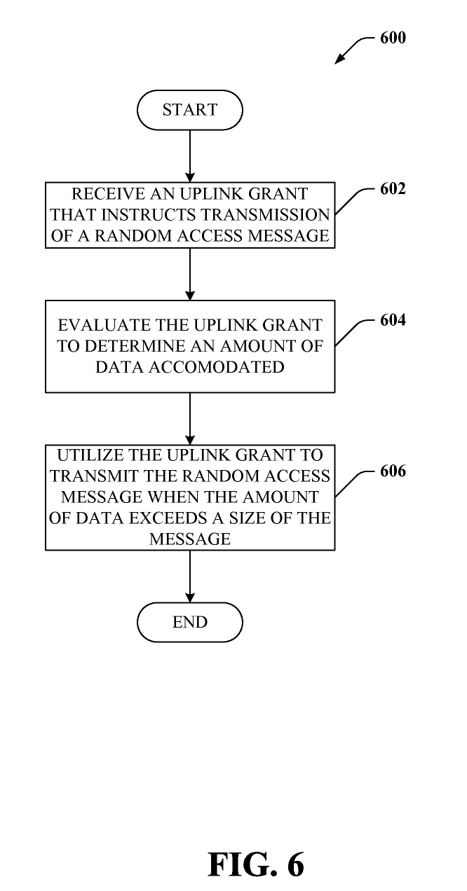

Referring now to FIG. 6, a method 600 is depicted that facilitates verifying that a random access transmissions is possible with a given uplink grant. Method 600 can be employed, for example, by a mobile device with an ongoing random access procedure. At reference numeral 602, an uplink grant is received. In one example, the uplink grant can instruct transmission of a random access message (e.g., message 3, scheduled uplink message 236, etc.). At reference numeral 604, the uplink grant is evaluated to determine an amount of data accommodated by the grant. For instance, the uplink grant specifies a set of uplink resources which have a limit on an amount of data that can be conveyed via the resources for a given transmission time interval. At reference numeral 606, the uplink grant is utilized to transmit the random access message when the amount of data exceeds a size of the random access message.

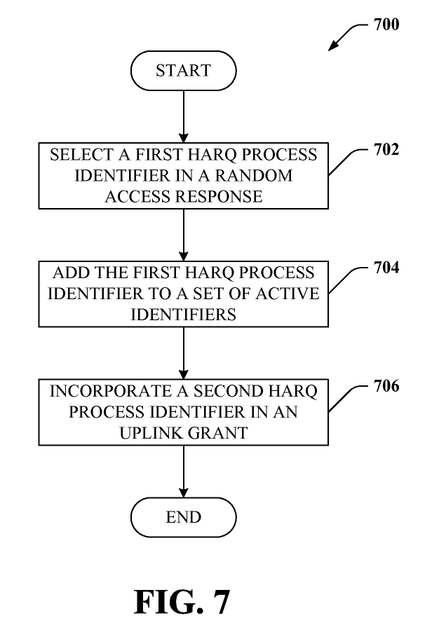

Turning now to FIG. 7, illustrated is a method 700 for avoiding a deadlock condition during random access in accordance with various aspects. Method 700 can be employed, for example, by a base station in a wireless communication network. At reference numeral 702, a first HARQ process identifier is selected for a random access response. At reference numeral 704, the first HARQ process identifier is added to a set of active identifiers, wherein each identifier in the set of active identifiers is associated with a random access procedure. At reference numeral 706, a second HARQ process identifier is incorporated in an uplink grant. According to an aspect, the second HARQ process identifier is not included in the set of active identifiers.

It will be appreciated that, in accordance with one or more aspects described herein, inferences can be made regarding selecting a random access preamble, evaluating uplink grants, determining whether to utilize or to disregard uplink grants, and the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

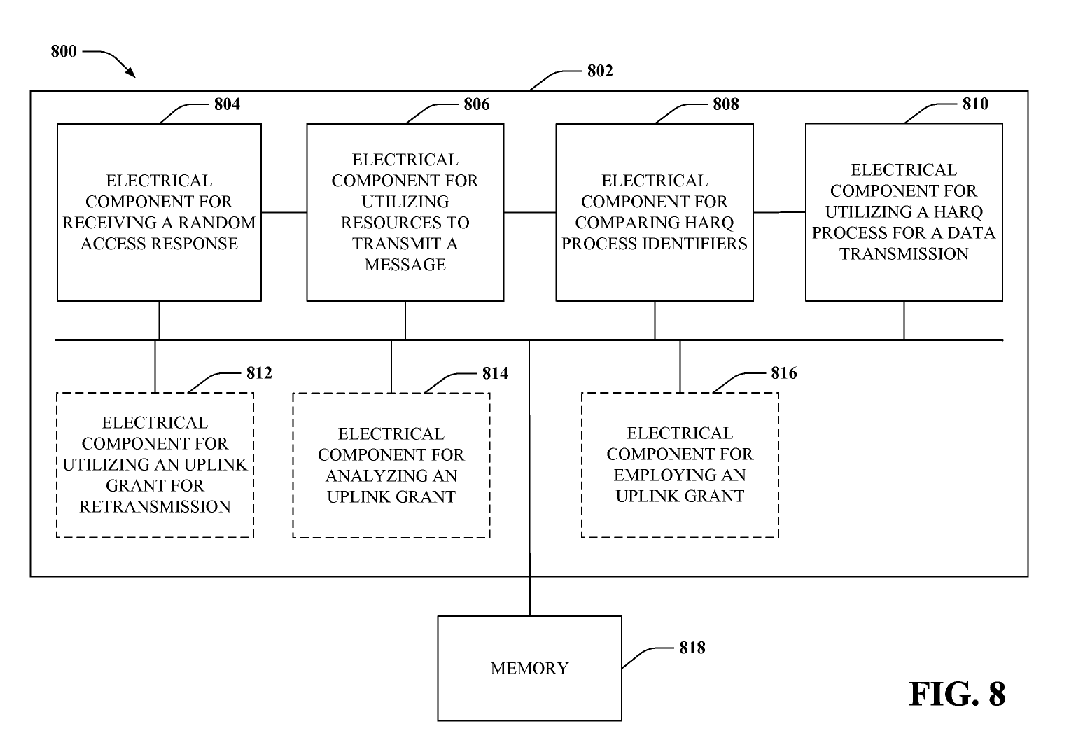

With reference to FIG. 8, illustrated is a system 800 that facilitates avoidance of deadlock situations during random access in accordance with various aspects. For example, system 800 can reside at least partially within a user equipment unit. It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction. For instance, logical grouping 802 can include an electrical component for receiving random access response 1104. The random access response can include a first uplink grant and a first HARQ process identifier. Further, logical grouping 802 can comprise an electrical component for utilizing resources to transmit a message 806. In an example, the resources can be a set of resources specified in the first uplink grant. In addition, a HARQ process associated with the first HARQ process identifier can be utilized to facilitate transmission of the message. Moreover, logical grouping 802 can comprise an electrical component for comparing HARQ process identifiers 808. The electrical component 808 can be employed to compare the first HARQ process identifier with a second HARQ process identifier included in a second uplink grant. Logical grouping 802 can also include an electrical component 810 for utilizing the second HARQ process identifier for a data transmission. In accordance with an aspect, the second HARQ process identifier can be utilized for the data transmission when the second identifier differs from the first identifier.

Optionally, logical grouping 802 can include an electrical component 812 for utilizing an uplink grant for retransmission, an electrical component 814 for analyzing an uplink grant to determine an amount of data that can be accommodated, and an electrical component 816 for employing an uplink grant when the amount of data exceeds a size of a message. Additionally, system 800 can include a memory 818 that retains instructions for executing functions associated with electrical components 804-816. While shown as being external to memory 818, it is to be understood that one or more of electrical components 804, 806, 808, 810, 812, 814, and 816 can exist within memory 818.

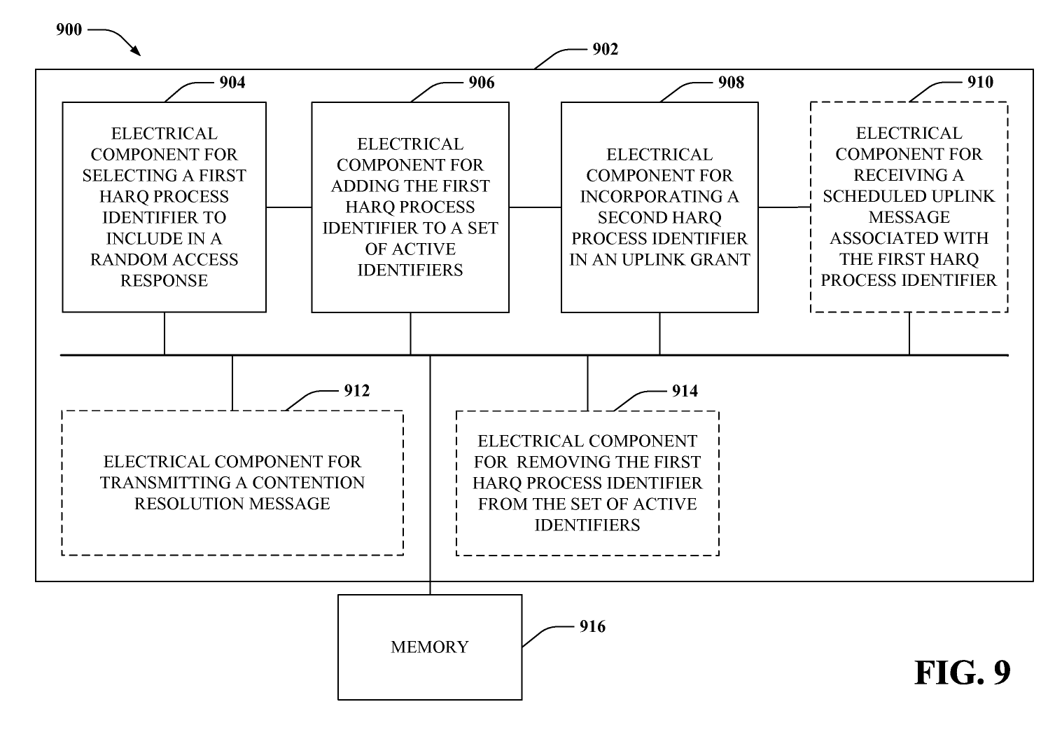

With reference to FIG. 9, illustrated is a system 900 that facilitates avoidance of deadlock situations during random access in accordance with various aspects. For example, system 900 can reside at least partially within a user equipment unit. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include an electrical component for selecting a first HARQ process identifier to include in a random access response 904. Further, logical grouping 1202 can comprise an electrical component for adding the first HARQ process identifier to a set of active identifiers 906. Moreover, logical grouping 902 can comprise an electrical component 908 for incorporating a second HARQ process identifier in an uplink grant, wherein the second HARQ process identifier is not within the set of active identifiers. Optionally, logical grouping 902 can also include an electrical component 910 for receiving a scheduled uplink message associated with the first HARQ process identifier, an electrical component 912 for transmitting a contention resolution message, an electrical component 914 for removing the first HARQ process identifier from the set of active identifier. Additionally, system 900 can include a memory 916 that retains instructions for executing functions associated with electrical components 904, 906, 908, 910, 912, and 914. While shown as being external to memory 916, it is to be understood that one or more of electrical components 904, 906, 908, 910, 912, and 914 can exist within memory 916.

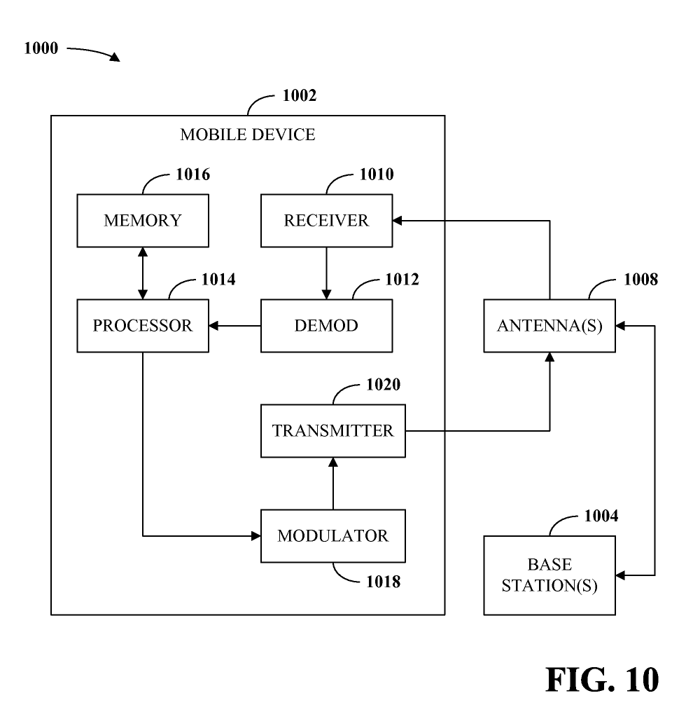

FIG. 10 is a block diagram of another system 1000 that can be utilized to implement various aspects of the functionality described herein. In one example, system 1000 includes a mobile device 1002. As illustrated, mobile device 1002 can receive signal(s) from one or more base stations 1004 and transmit to the one or more base stations 1004 via one or more antennas 1008. Additionally, mobile device 1002 can comprise a receiver 1010 that receives information from antenna(s) 1008. In one example, receiver 1010 can be operatively associated with a demodulator (Demod) 1012 that demodulates received information. Demodulated symbols can then be analyzed by a processor 1014. Processor 1014 can be coupled to memory 1016, which can store data and/or program codes related to mobile device 1002. Mobile device 1002 can also include a modulator 1018 that can multiplex a signal for transmission by a transmitter 1020 through antenna(s) 1008.

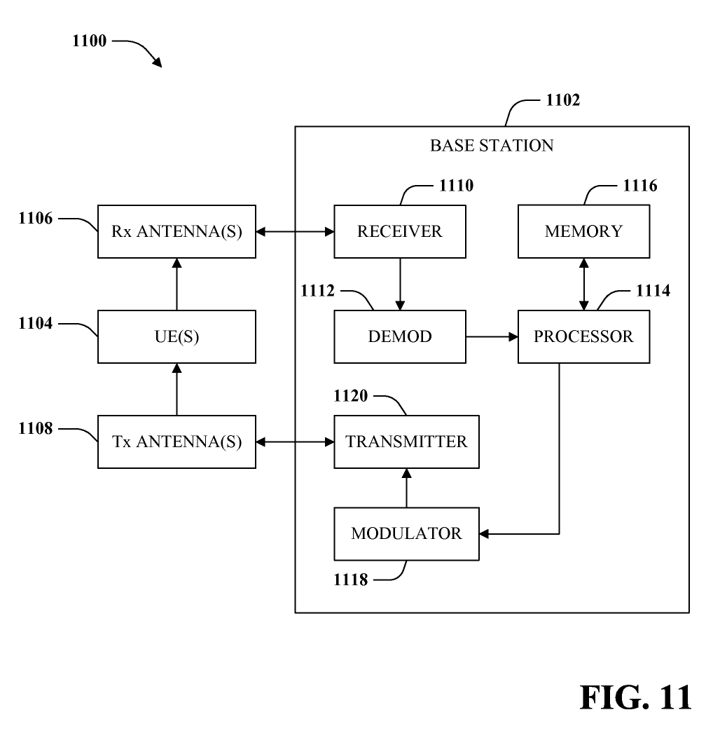

FIG. 11 is a block diagram of a system 1100 that can be utilized to implement various aspects of the functionality described herein. In one example, system 1100 includes a base station or base station 1102. As illustrated, base station 1102 can receive signal(s) from one or more UEs 1104 via one or more receive (Rx) antennas 1106 and transmit to the one or more UEs 1104 via one or more transmit (Tx) antennas 1108. Additionally, base station 1102 can comprise a receiver 1110 that receives information from receive antenna(s) 1106. In one example, the receiver 1110 can be operatively associated with a demodulator (Demod) 1112 that demodulates received information. Demodulated symbols can then be analyzed by a processor 1114. Processor 1114 can be coupled to memory 1116, which can store information related to code clusters, access terminal assignments, lookup tables related thereto, unique scrambling sequences, and/or other suitable types of information. Base station 1102 can also include a modulator 1118 that can multiplex a signal for transmission by a transmitter 1120 through transmit antenna(s) 1108.

A wireless multiple-access communication system may simultaneously support communication for multiple wireless access terminals. As mentioned above, each terminal may communicate with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

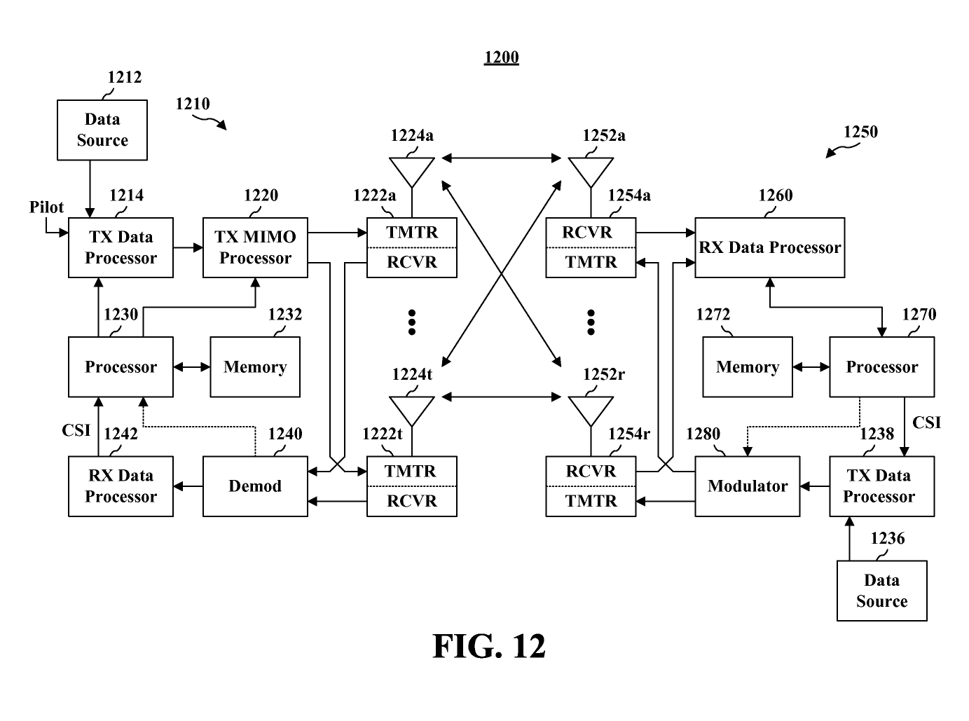

FIG. 12 shows an example wireless communication system 1200. The wireless communication system 1200 depicts one base station 1210 and one access terminal 1250 for sake of brevity. However, it is to be appreciated that system 1200 can include more than one base station and/or more than one access terminal, wherein additional base stations and/or access terminals can be substantially similar or different from example base station 1210 and access terminal 1250 described below. In addition, it is to be appreciated that base station 1210 and/or access terminal 1250 can employ the systems (FIGS. 1-4 and FIGS. 8-9) and/or method (FIGS. 5-7) described herein to facilitate wireless communication there between.

At base station 1210, traffic data for a number of data streams is provided from a data source 1212 to a transmit (TX) data processor 1214. According to an example, each data stream can be transmitted over a respective antenna. TX data processor 1214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 1250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1230.

The modulation symbols for the data streams can be provided to a TX MIMO processor 1220, which can further process the modulation symbols (e.g., for OFDM). TX MIMO processor 1220 then provides N_{T} modulation symbol streams to N_{T} transmitters (TMTR) 1222a through 1222t. In various embodiments, TX MIMO processor 1220 applies beamforming weights to the symbols of the data streams and to the antenna from which the symbol is being transmitted.

Each transmitter 1222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1222a through 1222t are transmitted from N_{T} antennas 1224a through 1224t, respectively.

At access terminal 1250, the transmitted modulated signals are received by N_{R} antennas 1252a through 1252r and the received signal from each antenna 1252 is provided to a respective receiver (RCVR) 1254a through 1254r. Each receiver 1254 conditions (e.g., filters, amplifies, and downconverts) a respective signal, digitizes the conditioned signal to provide samples, and further processes the samples to provide a corresponding “received” symbol stream.

An RX data processor 1260 can receive and process the N_{R} received symbol streams from N_{R} receivers 1254 based on a particular receiver processing technique to provide N_{T} “detected” symbol streams. RX data processor 1260 can demodulate, deinterleave, and decode each detected symbol stream to recover the traffic data for the data stream. The processing by RX data processor 1260 is complementary to that performed by TX MIMO processor 1220 and TX data processor 1214 at base station 1210.

A processor 1270 can periodically determine which available technology to utilize as discussed above. Further, processor 1270 can formulate a reverse link message comprising a matrix index portion and a rank value portion.

The reverse link message can comprise various types of information regarding the communication link and/or the received data stream. The reverse link message can be processed by a TX data processor 1238, which also receives traffic data for a number of data streams from a data source 1236, modulated by a modulator 1280, conditioned by transmitters 1254a through 1254r, and transmitted back to base station 1210.

At base station 1210, the modulated signals from access terminal 1250 are received by antennas 1224, conditioned by receivers 1222, demodulated by a demodulator 1240, and processed by a RX data processor 1242 to extract the reverse link message transmitted by access terminal 1250. Further, processor 1230 can process the extracted message to determine which precoding matrix to use for determining the beamforming weights.

Processors 1230 and 1270 can direct (e.g., control, coordinate, manage, etc.) operation at base station 1210 and access terminal 1250, respectively. Respective processors 1230 and 1270 can be associated with memory 1232 and 1272 that store program codes and data. Processors 1230 and 1270 can also perform computations to derive frequency and impulse response estimates for the uplink and downlink, respectively.

In an aspect, logical channels are classified into Control Channels and Traffic Channels. Logical Control Channels can include a Broadcast Control Channel (BCCH), which is a DL channel for broadcasting system control information. Further, Logical Control Channels can include a Paging Control Channel (PCCH), which is a DL channel that transfers paging information. Moreover, the Logical Control Channels can comprise a Multicast Control Channel (MCCH), which is a Point-to-multipoint DL channel used for transmitting Multimedia Broadcast and Multicast Service (MBMS) scheduling and control information for one or several MTCHs. Generally, after establishing a Radio Resource Control (RRC) connection, this channel is only used by UEs that receive MBMS (e.g., old MCCH+MSCH). Additionally, the Logical Control Channels can include a Dedicated Control Channel (DCCH), which is a Point-to-point bi-directional channel that transmits dedicated control information and can be used by UEs having a RRC connection. In an aspect, the Logical Traffic Channels can comprise a Dedicated Traffic Channel (DTCH), which is a Point-to-point bi-directional channel dedicated to one UE for the transfer of user information. Also, the Logical Traffic Channels can include a Multicast Traffic Channel (MTCH) for Point-to-multipoint DL channel for transmitting traffic data.

In an aspect, Transport Channels are classified into DL and UL. DL Transport Channels comprise a Broadcast Channel (BCH), a Downlink Shared Data Channel (DL-SDCH) and a Paging Channel (PCH). The PCH can support UE power saving (e.g., Discontinuous Reception (DRX) cycle can be indicated by the network to the UE, . . . ) by being broadcasted over an entire cell and being mapped to Physical layer (PHY) resources that can be used for other control/traffic channels. The UL Transport Channels can comprise a Random Access Channel (RACH), a Request Channel (REQCH), an Uplink Shared Data Channel (UL-SDCH) and a plurality of PHY channels.

The PHY channels can include a set of DL channels and UL channels. For example, the DL PHY channels can include: Common Pilot Channel (CPICH); Synchronization Channel (SCH); Common Control Channel (CCCH); Shared DL Control Channel (SDCCH); Multicast Control Channel (MCCH); Shared UL Assignment Channel (SUACH); Acknowledgement Channel (ACKCH); DL Physical Shared Data Channel (DL-PSDCH); UL Power Control Channel (UPCCH); Paging Indicator Channel (PICH); and/or Load Indicator Channel (LICH). By way of further illustration, the UL PHY Channels can include: Physical Random Access Channel (PRACH); Channel Quality Indicator Channel (CQICH); Acknowledgement Channel (ACKCH); Antenna Subset Indicator Channel (ASICH); Shared Request Channel (SREQCH); UL Physical Shared Data Channel (UL-PSDCH); and/or Broadband Pilot Channel (BPICH).

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
obtaining an uplink grant that specifies a first HARQ process identifier;
identifying whether the first HARQ process identifier is associated with an ongoing random access procedure; and
disregarding the uplink grant when the first HARQ process identifier is associated with the ongoing random access procedure.

2. The method of claim 1, further comprising:
evaluating the uplink grant to determine an amount of data capable of transmission with the uplink grant; and
verifying that the amount of data is greater than or equal to a size of a transport block associated with a scheduled uplink message during random access.

3. The method of claim 1, further comprising:
determining whether the uplink grant indicates a retransmission; and
utilize the uplink grant to transmit a scheduled uplink message associated with random access.

4. The method of claim 1, wherein the uplink grant is included in a contention resolution message.

5. The method of claim 1, wherein the uplink grant is addressed to a cell radio network temporary identifier that identifies a mobile device within a cell.

6. The method of claim 1, wherein the ongoing random access procedure is initiated to reacquire uplink synchronization.

7. An apparatus, comprising:
a random access module that facilitates a random access procedure, wherein the random access procedure results in at least one of creation of a radio link or reacquisition of uplink synchronization; and
a HARQ module that facilitates HARQ operations for one or more data transmissions,
wherein the HARQ module includes a HARQ process with a first identifier, the HARQ process is employed to facilitate transmission of a scheduled uplink message generated by the random access module, the HARQ module ignores an uplink grant that includes the first identifier when the uplink grant specifies a new transmission.

8. The apparatus of claim 7, wherein the random access module further comprises a contention response evaluation module that analyzes a contention response message to determine a HARQ process identifier associated with the uplink grant included in the contention response message.

9. The apparatus of claim 8, wherein the HARQ module is configured to disregard the uplink grant included in the contention response message when the HARQ process identifier is identical to the first identifier.

10. The apparatus of claim 7, wherein the random access module further comprises a grant evaluation module that analyzes the uplink grant to ascertain an amount of data accommodated by the uplink grant.

11. The apparatus of claim 10, wherein the HARQ module ignores the uplink grant when the amount of data accommodated is less than a size of the scheduled uplink message.

12. A wireless communication apparatus, comprising:
means for receiving a random access response that includes a first uplink grant and a first HARQ process identifier;
means for utilizing a set of resources specified in the first uplink grant and a HARQ process specified by the first HARQ process identifier to transmit a scheduled uplink message;
means for receiving a second uplink grant that includes a second HARQ process identifier;
means for comparing the first HARQ process identifier and the second HARQ process identifier; and
means for employing the second uplink grant for a data transmission when the first HARQ process identifier is different from the second HARQ process identifier.

13. The wireless communication apparatus of claim 12, further comprising:
means for utilizing the second uplink grant for retransmission of the scheduled uplink message when the first HARQ process identifier and the second HARQ process identifier are identical, wherein a new data indicator is not included in the second uplink grant.

14. The wireless communication apparatus of claim 12, further comprising:
means for analyzing the first uplink grant to ascertain an amount of data accommodated by the set of resources specified therein; and
means for employing the first uplink grant when a size of the scheduled uplink message is less than or equal to the amount of data.

15. The wireless communication apparatus of claim 12, wherein the second uplink grant is associated with a cell radio network temporary identifier.

16. The wireless communication apparatus of claim 12, wherein the second uplink grant is included in a contention resolution message.

17. The wireless communication apparatus of claim 12, wherein the second uplink grant is a dynamic uplink grant.

18. A computer program product, comprising:
a computer-readable medium, comprising
code for causing at least one computer to evaluate a random access response to determine a first set of resources and a first HARQ process specified in the random access response;
code for causing the at least one computer to employ the first set of resources to transmit a scheduled uplink message that includes an identity of a mobile device;
code for causing the at least one computer to utilize the first HARQ process to facilitate error-free transmission of the scheduled uplink message;
code for causing the at least one computer to evaluate a second uplink grant to determine a second set of resources and a second HARQ process; and
code for causing the at least one computer to disregard the second uplink grant when the first HARQ process is identical to the second HARQ process.

19. The computer program product of claim 18, the computer-readable medium further comprising:
code for causing the at least one computer to identify an amount of data accommodated by the first set of resources; and
code for causing the at least one computer to utilize the first set of resources when a size of the scheduled uplink message is less than or equal to the amount of data.

20. The computer program product of claim 18, wherein the computer-readable medium further comprising:
code for causing the at least one computer to evaluate the second uplink grant to determine whether a new data indicator is included; and
code for causing the at least one computer to utilize the second set of resources and the second HARQ process to transmit the scheduled uplink message, wherein the second HARQ process is identical to the first HARQ process.

21. The computer program product of claim 18, wherein the second uplink grant is included in a contention resolution message.

22. The computer program product of claim 18, wherein the code for causing the at least one computer to disregard the second uplink grant includes code for causing the at least one computer to ignore the second uplink grant while a random access procedure is ongoing.

23. The computer program product of claim 18, wherein the second uplink grant is a dynamic uplink grant.

24. A wireless communication apparatus, comprising:
a processor configured to:
evaluate a random access response that includes a first uplink grant and a first HARQ process identifier;
employ a set of resources specified in the first uplink grant and a HARQ process specified by the first HARQ process identifier to transmit a scheduled uplink message;
receive a second uplink grant that includes a second HARQ process identifier;
compare the first HARQ process identifier and the second HARQ process identifier; and
utilize the second uplink grant for a data transmission when the first HARQ process identifier is different from the second HARQ process identifier.

25. The wireless communication apparatus of claim 24, wherein the processor is further configured to employ the second uplink grant for retransmission of the scheduled uplink message when the first HARQ process identifier and the second HARQ process identifier are identical, wherein a new data indicator is not included in the second uplink grant.

26. The wireless communication apparatus of claim 24, wherein the processor is further configured to:
evaluate the first uplink grant to ascertain an amount of data accommodated by the set of resources specified therein; and
utilize the first uplink grant when a size of the scheduled uplink message is within the amount of data.

27. The wireless communication apparatus of claim 24, wherein the second uplink grant is associated with a cell radio network temporary identifier.

28. The wireless communication apparatus of claim 24, wherein the second uplink grant is included in a contention resolution message.

29. The wireless communication apparatus of claim 24, wherein the second uplink grant is a dynamic uplink grant.

30. A method, comprising:
selecting a first HARQ process identifier to include in a random access response;
including the first HARQ process identifier in a set of active identifiers that utilized for random access procedures by one or more mobile devices; and
incorporating a second HARQ process identifier in an uplink grant, wherein the second HARQ process identifier is not included in the set of active identifiers.

31. The method of claim 30, further comprising:
receiving a scheduled uplink message associated with the first HARQ process identifier, wherein the scheduled uplink message includes an identity of a mobile device;
transmitting a contention resolution message, wherein the contention resolution message includes the identity of the mobile device and a set of uplink resources for an uplink data transmission; and
removing the first HARQ process identifier from the set of active identifiers.

32. The method of claim 31, wherein the contention resolution message includes a third HARQ process identifier disjoint with the set of active identifiers.

33. The method of claim 30, wherein the random access response specifies uplink resources to employ for a scheduled uplink message, wherein an amount of data accommodated by the uplink resources exceeds a size of the scheduled uplink message.

34. An apparatus, comprising:
a memory that retains instructions related to selecting a first HARQ process identifier to include in a random access response, including the first HARQ process identifier in a set of active identifiers that utilized for random access procedures by one or more mobile devices, and incorporating a second HARQ process identifier in an uplink grant, wherein the second HARQ process identifier is not included in the set of active identifiers; and
a processor, coupled to the memory, configured to execute the instructions retained in the memory.

35. The apparatus of claim 34, wherein the memory further retains instructions related to receiving a scheduled uplink message associated with the first HARQ process identifier, wherein the scheduled uplink message includes an identity of a mobile device, transmitting a contention resolution message, wherein the contention resolution message includes the identity of the mobile device and a set of uplink resources for an uplink data transmission, and removing the first HARQ process identifier from the set of active identifiers.

36. The apparatus of claim 35, wherein the contention resolution message includes a third HARQ process identifier disjoint with the set of active identifiers.

37. The apparatus of claim 34, wherein the random access response specifies uplink resources employable for a scheduled uplink message, wherein an amount of data accommodated by the uplink resources exceeds a size of the scheduled uplink message.

38. A wireless communication apparatus, comprising:
means for selecting a first HARQ process identifier to include in a random access response;
means for adding the first HARQ process identifier in a set of active identifiers that utilized for random access procedures by one or more mobile devices; and
means for incorporating a second HARQ process identifier in an uplink grant, wherein the second HARQ process identifier is not included in the set of active identifiers.

39. The wireless communication apparatus of claim 38, further comprising:
means for receiving a scheduled uplink message associated with the first HARQ process identifier, wherein the scheduled uplink message includes an identity of a mobile device;
means for transmitting a contention resolution message, wherein the contention resolution message includes the identity of the mobile device and a set of uplink resources for an uplink data transmission; and
means for removing the first HARQ process identifier from the set of active identifiers.

40. The wireless communication apparatus of claim 39, wherein the contention resolution message includes a third HARQ process identifier disjoint with the set of active identifiers.

41. The wireless communication apparatus of claim 39, wherein the random access response specifies uplink resources to employ for the scheduled uplink message, wherein an amount of data accommodated by the uplink resources exceeds a size of the scheduled uplink message.

42. A computer program product, comprising:
a computer-readable medium, comprising
code for causing at least one computer to select a first HARQ process identifier to include in a random access response;
code for causing the at least one computer to add the first HARQ process identifier in a set of active identifiers that utilized for random access procedures by one or more mobile devices; and
code for causing the at least one computer to incorporate a second HARQ process identifier in an uplink grant, wherein the second HARQ process identifier is not included in the set of active identifiers.

43. The computer program product of claim 42, wherein the computer-readable medium further comprising:
code for causing the at least one computer to receive a scheduled uplink message associated with the first HARQ process identifier, wherein the scheduled uplink message includes an identity of a mobile device;
code for causing the at least one computer to transmit a contention resolution message, wherein the contention resolution message includes the identity of the mobile device and a set of uplink resources for an uplink data transmission; and
code for causing the at least one computer to remove the first HARQ process identifier from the set of active identifiers.

44. A wireless communication apparatus, comprising:
a processor configured to:
select a first HARQ process identifier to include in a random access response;
include the first HARQ process identifier in a set of active identifiers that utilized for random access procedures by one or more mobile devices; and
incorporate a second HARQ process identifier in an uplink grant, wherein the second HARQ process identifier is not included in the set of active identifiers.

45. The wireless communication apparatus of claim 44, the processor further configured to:
receive a scheduled uplink message associated with the first HARQ process identifier, wherein the scheduled uplink message includes an identity of a mobile device;
transmit a contention resolution message, wherein the contention resolution message includes the identity of the mobile device and a set of uplink resources for an uplink data transmission; and
remove the first HARQ process identifier from the set of active identifiers.
